(19) United States
(12) Patent Application Publication
(10) Pub. No.: US 2024/0273867 A1
(43) Pub. Date: Aug. 15, 2024

(54) DEVICE AND METHOD FOR DETERMINING A CLASS FOR AT LEAST A PART OF A DIGITAL IMAGE

(71) Applicant: Robert Bosch GmbH, Stuttgart (DE)

(72) Inventors: Dan Zhang, Leonberg (DE); Andreas Geiger, Wannweil (DE); Haiwen Huang, Tübingen (DE)

(21) Appl. No.: 18/429,105

(22) Filed: Jan. 31, 2024

(30) Foreign Application Priority Data
Feb. 15, 2023 (EP) 23 15 6748.8

(51) Int. Cl. G06V 10/764; G06V 10/22; G06V 10/774

(52) U.S. Cl. CPC G06V 10/764; G06V 10/225; G06V 10/774

(57) ABSTRACT

A device and a method for determining a class for at least a part of a digital image. The method includes: providing a classifier for a first class and a second class; determining a digital image including an object of the second class in at least the part of the digital image; determining the class for at least the part of the digital image with the classifier, wherein determining the digital image includes determining the object of the second class with a generative model depending on a label for the first class and/or depending on at least one pixel representing an object of the first class.

### CROSS REFERENCE

The present application claims the benefit under 35 U.S.C. § 119 of European Patent Application No. EP 23 15 6748.8 filed on Feb. 15, 2023, which is expressly incorporated herein by reference in its entirety.

### BACKGROUND INFORMATION

The present invention relates to a device and a method for determining a class for at least a part of a digital image.

Digital images are processed for object detection and semantic segmentation.

Object detection identifies a category of an object depicted in the digital image. A bounding box describes a part of the digital image. The bounding box localizes an object that is depicted in the part of the digital image. The category may be associated with the pixels forming the object or the bounding box comprising the object.

Semantic segmentation associates a category with pixels in the digital image. Semantic segmentation may be used to recognize a collection of pixels that form a category, e.g. an object or background.

Saito, Kuniaki, et al. “Learning to Detect Every Thing in an Open World.” arXiv preprint arXiv: 2112.01698 (2021) describes a method for open-set object detection.

### SUMMARY

A method and the device according to the present invention determine a class for at least a part of a digital image. The class may be associated with a pixel, an object or a bounding box that identifies the part of the digital image.

According to an example embodiment of the present invention, the method for determining the class for at least a part of the digital image comprises providing a classifier for a first class and a second class, determining a digital image comprising an object of the second class in at least the part of the digital image, determining the class for at least the part of the digital image with the classifier, wherein determining the digital image comprises determining the object of the second class with a generative model depending on a label for the first class and/or depending on at least one pixel representing an object of the first class. The resulting digital image comprises a synthesized object of the second class. The class that the classifier determines may be used for training.

According to an example embodiment of the present invention, the method may comprise training the classifier to determine the second class for the object of the second class in the digital image.

According to an example embodiment of the present invention, the method may comprise training the classifier to determine the second class for a pixel in the digital images forming at least a part of the object of the second class.

According to an example embodiment of the present invention, the method may comprise training the classifier to determine the second class for a bounding box in the digital image comprising the object of the second class.

Determining the digital image may comprise replacing or modifying a part of the digital image to form at least the part of the digital image.

The method may comprise determining the part of the digital image with the generative model, in particular from random noise or with latent space interpolation.

The method may comprise training the generative model to synthesize the part of the digital image, in particular from random noise or with latent space interpolation.

The method may comprise determining the part of the digital image with the generative model depending on a predetermined mask, or determining at least the part of the digital image with the generative model depending on a predetermined bounding box. This means, the generative model is utilized to synthesize at least the part of the digital image depending on the predetermined mask or bounding box.

The method may comprise determining the mask identifying the pixels of at least the part of the digital image with the generative model. The generative model is utilized to synthesize the mask.

The method may comprise training the generative model to synthesize at least the part of the digital image depending on the mask or the bounding box.

According to an example embodiment of the present invention, the device for determining the class for at least a part of a digital image comprises at least one processor and at least one storage, wherein the storage is adapted to store instructions that when executed by the at least one processor cause the at least one processor to perform steps in the method, and wherein the at least one processor is configured to execute the instructions. The device provides advantages that correspond to the advantages of the method according to the present invention.

According to an example embodiment of the present invention, a program for determining a class for at least a part of a digital image comprises instructions that are executable by at least one processor, wherein the instructions, when executed by the at least one processor, cause the at least one processor to execute the method according to the present invention.

Further advantageous embodiments of the present invention are derived from the following description and the figures.

### BRIEF DESCRIPTION OF THE DRAWINGS

FIG. 1 schematically depicts a device for determining a class for at least a part of a digital image, according to an example embodiment of the present invention.

FIG. 2 depicts a method for determining a class for at least a part of a digital image, according to an example embodiment of the present invention.

### DETAILED DESCRIPTION OF EXAMPLE EMBODIMENTS

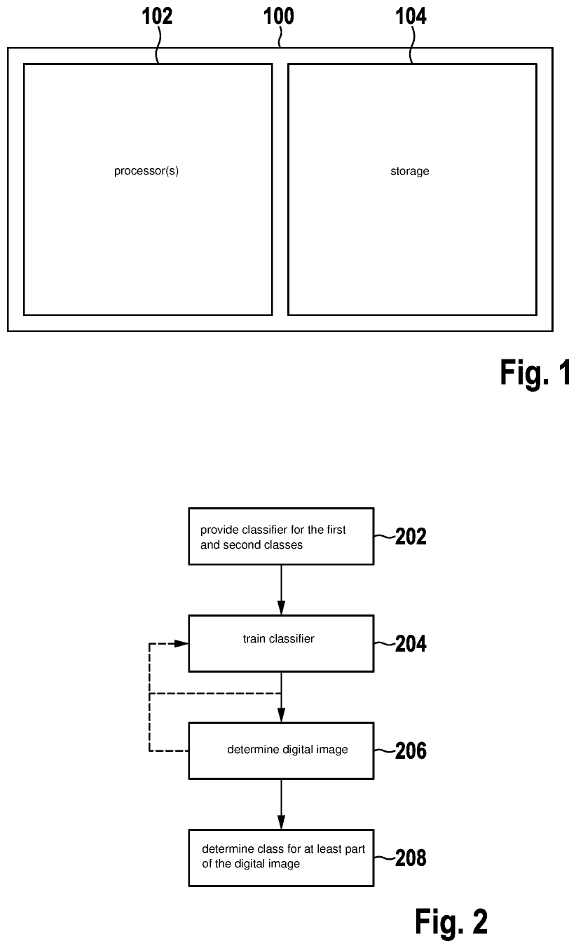

FIG. 1 schematically depicts a device 100 for determining a class for at least a part of a digital image.

Digital image in this context may refer to a RGB image or monochrome image.

The device 100 comprises at least one processor 102 and at least one storage 104.

The at least one storage 104 may comprise at least one non-volatile storage. The at least one storage 104 is adapted to store instructions that when executed by the at least one processor 102 cause the at least one processor 102 to execute a method for determining the class.

The at least one processor 102 is configured to execute the instructions.

A program that is executable by the at least one processor 102 may comprise the instructions for determining the class.

The device 100 comprises a classifier. The classifier is implemented as part of the instructions in software, hardware, or partially in software and partially in hardware.

The classifier is configured for at least one class for known objects and a class for novel or unknown objects. For example, the classifier comprises K classification heads for known classes and one classification head for the class for novel or unknown objects.

Examples for a known class are vehicle, pedestrian, traffic sign, and pavement. Other road features may be unknown to the classifier. The classifier is configured to classify the other road features in the class for novel or unknown objects.

The classifier is trained with training data comprising digital images comprising known objects.

The classifier is trained with augmented training data wherein digital images comprise novel or unknown objects.

The device 100 comprises a generative model. The generative model is implemented as part of the instructions in software, hardware, or partially in software and partially in hardware.

The generative model is used to determine the augmented training data from the training data.

For example, the generative model is configured to synthesize a novel object through random noise sampling or latent space interpolation.

For example, the generative model is configured to synthesize at least a part of a digital image depending on a predetermined mask or bounding box.

For example, the generative model is configured to synthesize the mask.

For example, the generative model is pre-trained and utilized to synthesize at least a part of a digital image depending on a predetermined mask or bounding box or to synthesize the mask.

The novel object is for example copy-pasted for example randomly into an original image of the training data to create a novel image in the augmented training data having a label for the pasted part that is indicative of the class for novel or unknown objects.

An object in the original image is for example interchanged with the novel object to create a novel image in the augmented training data having a label for the pasted part that is indicative of the class for novel or unknown objects.

For example, the generative model is configured to synthesize a background through random noise sampling or latent space interpolation.

An object in the original image is for example replaced by the background in the original images to create a novel image in the augmented training data having for the pasted part neither a label that is indicative of the class for novel or unknown objects nor a label that is indicative of the class for known objects. This provides a clean background without any object in the area.

The method is described for parts of digital images. A part of the digital image is a pixel, pixel of at least a part of an object or a bounding box comprising an object.

The method is described for a first class and a second class.

The first class is used for the known objects. The second class is used for the novel or unknown objects.

The method applies as well to known objects of different known classes. The method may distinguish in this case one class for novel or unknown objects from several different classes for known objects.

The method may classify the part of the digital image for semantic segmentation or object detection. In semantic segmentation either the first class or the second class is assigned to a pixel. In object detection either the first class or the second class is assigned to an object or a bounding box for an object.

The method comprises a step 202.

In the step 202, the classifier for the first class and the second class is provided.

The method comprises a step 204.

In the step 204, the classifier is trained with training data. The training data comprises digital images and a label for the first class that is assigned to objects of the first class.

The method comprises a step 206.

In the step 206, a digital image is determined. The digital image comprises at least one object of the second class.

Determining the digital image may comprise replacing or modifying a part of the digital image. In one example, the digital image is a selected digital image from the training data that is modified. In one example, the digital image is a newly generated digital image.

The part of the digital image is for example determined with the generative model depending on a predetermined mask. The generative model is for example trained to synthesize the part of the digital image depending on the predetermined mask.

The mask may identify the pixels of at least the part of the digital image that shall be replaced or modified. The mask may be determined with the generative model. The generative model may be trained to determine the mask.

The part of the digital image is for example determined with the generative model depending on a predetermined bounding box. The generative model is for example trained to synthesize the part of the digital image depending on the bounding box.

At least the part of the digital image may be determined with the generative model depending on the label for the first class.

At least the part of the digital image may be determined with the generative model depending on at least one pixel representing an object of the first class.

The method may comprise training the generative model to synthesize at least the part of the digital image.

The method may comprise training the generative model to synthesize at least the part of the digital image from random noise. At least the part of the digital image may be determined with the generative model from random noise.

The method may comprise training the generative model to synthesize at least the part of the digital image with latent space interpolation. At least the part of the digital image may be determined with the generative model with latent space interpolation.

The generative model may be trained to synthesize at least the part of the digital image depending on a mask identifying pixels of at least the part of the digital image. The method may comprise determining the mask depending on the digital image.

The step 206 may be repeated to determine different digital images from the same digital image.

The steps 204 and 206 may be repeated to determine different digital images for different digital images.

The step 206 may be repeated to train the classifier with different digital images.

The method comprises a step 208.

In the step 208, the class is determined for at least the part of the digital image.

For example, either the first class or the second class is determined for the part of the digital image. For several classes of known objects, either the one class for novel or unknown objects or one of the several different classes for known objects is determined.

This class is for example determined for a pixel in the digital images forming at least a part of the object of the second class.

The class is for example determined for the object of the second class in the digital image.

The class is for example determined for a bounding box in the digital image comprising the object of the second class.

The method may comprise training the classifier

The method may comprise training the classifier to determine the second class for a pixel in the digital images forming at least a part of the object of the second class.

The method may comprise training the classifier to determine the second class for the object of the second class in the digital image.

The method may comprise training the classifier to determine the second class for a bounding box in the digital image comprising the object of the second class

Training the generative model for generating objects may comprise training the generative model with digital images of a training data set wherein a digital image represents a scene and contains multiple objects.

According to one example, for training the generative model for novel object generation, the training data set is determined that comprises single object images. For example, bounding boxes are determined in the digital image of the training data set wherein the pixels in a bounding box form a single object image.

The mask may be an object mask. The object mask identifies, in particular with a binary value of Zero, a pixel of the digital image or the bounding box not belonging to the single object. The object mask identifies, in particular with a binary value 1, a pixel of the digital image or the bounding box belonging to the single object.

The generative model may be a neural network G that is trained for example with a training data point comprising the single object image and the object mask to synthesize an image I, i.e. the digital image, and an object mask M from in particular random noise z:

$$I , M = G ( z )$$

The generative model may be a Projected GAN as described in Axel Sauer, Kashyap Chitta, Jens Müller, Andreas Geiger “Projected GANs Converge Faster” arXiv preprint arXiv: 2111.01007.

The Projected GAN may be class-conditional:

$$I , M = G ( z , y )$$

with a one-hot encoding vector y to indicate the class identity. The class-conditional Projected GAN may be used in inference to synthesize new looking images by using an interpolation of a first one-hot encoding vector y₁ and a second one-hot encoding vector y₂. For example, the vectors y₁ and y₂ are used to synthesize an image I and an object mask M from in particular random noise z depending on an interpolated encoding vector

$$y = a {y}_{1} + ( 1 - a ) {y}_{2}$$

wherein a∈[0,1] is a parameter.

According to one example, for object manipulation within the bounding box, the generative model is a MaskGIT as described in Huiwen Chang, Han Zhang, Lu Jiang, Ce Liu, William T. Freeman “MaskGIT: Masked Generative Image Transformer” arXiv preprint arXiv: 2202.04200

The generative model may be pre-trained on single object images. MaskGIT provides a class-conditional image editing and an image painting mode.

According to one example, for manipulating the object in the bounding box, the original object in the bounding box is interchanged with a new object that is synthesized with MaskGIT. According to one example, for manipulating the object in the bounding box, the original object in the bounding box is replaced by a background that is synthesized with MaskGIT.

The augmented training data set is for example determined by determining the digital image as a copy of a digital image from the training data set and pasting a novel object or several novel objects into the digital image. A random number of novel objects may be synthesized and/or pasted into the digital image of the augmented training data set. A novel object may be pasted at a random location in the digital image of the augmented training data set.

The novel object is in one example synthesized with the generative model. The novel object is in one example determined from an object that is synthesized with the generative model. The novel object may be a resized version of the object that is synthesized with the generative model. The novel object may be determined from the synthesized object using large scale jittering as described in Ghiasi, Golnaz, et al. “Simple copy-paste is a strong data augmentation method for instance segmentation.” Proceedings of the IEEE/CVF Conference on Computer Vision and Pattern Recognition. 2021.

After the pasting, the method may comprise removing objects from the digital image of the augmented training data set that are fully occluded. The method may comprise adding a new label identifying the class for novel or unknown objects to the bounding box comprising the novel object. The method may comprise updating the object mask indicating the pixels belonging to the novel object.

The augmented data set is for example determined by randomly selecting a class for a bounding box in the digital image of the training data set, i.e. a ground truth bounding box, and determining the digital image of the augmented training data set with the class-conditional Projected GAN. The bounding box and the label of the bounding box in the digital image of the augmented training data set stays the same after the augmentation.

The augmented training data set is for example determined by using the object mask of the digital image of the training data set for a bounding box in the digital image of the training data set, i.e., a ground truth bounding box, to remove the ground truth object that the ground truth bounding box comprises, and then use the generative model to perform background inpainting to determine the digital image of the augmented training data set.

What is claimed is:

1. A method for determining a class for at least a part of a digital image, the method comprising the following steps:
providing a classifier for a first class and a second class;
determining a digital image including an object of the second class in at least the part of the digital image;
determining the class for at least the part of the digital image with the classifier, wherein the determining of the digital image includes determining the object of the second class with a generative model depending on a label for the first class and/or depending on at least one pixel representing an object of the first class.

2. The method according to claim 1, further comprises:
training the classifier to determine the second class for the object of the second class in the digital image.

3. The method according to claim 1, further comprising:
training the classifier to determine the second class for a pixel in the digital image forming at least a part of the object of the second class.

4. The method according to claim 1, further comprising:
training the classifier to determine the second class for a bounding box in the digital image including the object of the second class.

5. The method according to claim 1, wherein the determining of the digital image includes replacing or modifying a part of the digital image to form at least the part of the digital image.

6. The method according to claim 1, further comprising:
determining the part of the digital image with the generative model, from random noise or with latent space interpolation.

7. The method according to claim 6, further comprising:
training the generative model to synthesize at least the part of the digital image, from random noise or with latent space interpolation or with latent space interpolation.

8. The method according to claim 4, further comprising:
(i) determining at least the part of the digital image with the generative model depending on a predetermined mask, or (ii) determining at least the part of the digital image with the generative model depending on a predetermined bounding box.

9. The method according to claim 8, further comprising:
determining the mask identifying the pixels of at least the part of the digital image with the generative model.

10. The method according to claim 8, further comprising:
training the generative model to synthesize at least the part of the digital image depending on the mask or the bounding box.

11. A device configured to determine a class for at least a part of a digital image, the device comprising:
at least one processor; and
at least one storage;
wherein the storage is adapted to store instructions for determining the class for the at least a part of a digital image, the instructions, when executed by the at lease one processor, causing the at least one processor to perform the following steps:
providing a classifier for a first class and a second class,
determining a digital image including an object of the second class in at least the part of the digital image, and
determining the class for at least the part of the digital image with the classifier, wherein the determining of the digital image includes determining the object of the second class with a generative model depending on a label for the first class and/or depending on at least one pixel representing an object of the first class.

12. A non-transitory storage medium on which is stored a program including instructions for determining a class for at least a part of a digital image, the instructions, when executed by at least one process, cause the at least one processor to perform the following steps:
providing a classifier for a first class and a second class,
determining a digital image including an object of the second class in at least the part of the digital image, and
determining the class for at least the part of the digital image with the classifier, wherein the determining of the digital image includes determining the object of the second class with a generative model depending on a label for the first class and/or depending on at least one pixel representing an object of the first class.
